(19) United States
(12) Patent Application Publication
(10) Pub. No.: US 2026/0178185 A1
(43) Pub. Date: Jun. 25, 2026

(54) CONTROL METHOD, CONTROL SYSTEM, AND MOBILE OBJECT

(71) Applicant: Sony Group Corporation, Tokyo (JP)

(72) Inventor: Hidehiro KOMATSU, Tokyo (JP)

(73) Assignee: Sony Group Corporation, Tokyo (JP)

(21) Appl. No.: 18/706,760

(22) PCT Filed: Sep. 28, 2022
(86) PCT No.: PCT/JP2022/036052

§ 371 Date: Mar. 2, 2026

(30) Foreign Application Priority Data
Nov. 17, 2021 (JP) 2021-187195

(51) Int. Cl. G06F 3/04883; H04N 23/62

(52) U.S. Cl. CPC G06F 3/04883; H04N 23/62

(57) ABSTRACT

[Problem] A posture of a camera of a mobile object is controlled by a simple operation.

[Solution] A control method according to an embodiment of the present disclosure includes acquiring posture information of an operation device that is able to be held or worn by a user on the basis of a sensing signal of a motion sensor provided in the operation device, executing/activating a remote control mode for remotely controlling a posture of an imaging device provided in a mobile object on the basis of a first user operation to the operation device, outputting, to the user, notification information indicating that the remote control mode has been executed/activated, and controlling the posture of the imaging device on the basis of the posture information during at least a part of a period in which the remote control mode is executed/activated.

### TECHNICAL FIELD

The present disclosure relates to a control method, a control system, and a mobile object.

### BACKGROUND ART

As a method of controlling flight of a drone, there are various methods such as a method of operating the flight by an operator (flight operator) who operates the flight of the drone, and a method of automatically flying a designated route. In a case where the drone is caused to fly by any of these methods and a desired direction is captured by a camera mounted on the drone during flight, it is necessary to remotely control the posture of the camera by an operator of the camera (camera operator). In this case, it is desirable that the orientation of the camera can be controlled by a simple operation.

### CITATION LIST

### Patent Document

Patent Document 1: Japanese Patent Application Laid-Open No. 2018-201240

### SUMMARY OF THE INVENTION

### Problems to be Solved by the Invention

The present disclosure has been made in view of the above-described problems, and an object of the present disclosure is to enable easy operation of a posture of a camera mounted on a mobile object.

### Solutions to Problems

A control method according to an embodiment of the present disclosure includes acquiring posture information of an operation device that is able to be held or worn by a user on the basis of a sensing signal of a motion sensor provided in the operation device, executing/activating a remote control mode for remotely controlling a posture of an imaging device provided in a mobile object on the basis of a first user operation to the operation device, outputting, to the user, notification information indicating that the remote control mode has been executed/activated, and controlling the posture of the imaging device on the basis of the posture information during at least a part of a period in which the remote control mode is executed/activated.

### BRIEF DESCRIPTION OF DRAWINGS

FIG. 1 is a diagram illustrating a drone control system according to a first embodiment.

FIG. 2 is a block diagram of a drone according to the first embodiment.

FIG. 3 is a view schematically illustrating an appearance of a triaxial gimbal according to the first embodiment.

FIG. 4 is a block diagram of a transmission device according to the first embodiment.

FIG. 5 is a view illustrating a display example of a display unit for notification of a setting state of a remote control mode according to the first embodiment.

FIG. 6 is a view illustrating another display example of the display unit for notification of the setting state of the remote control mode according to the first embodiment.

FIG. 7 is a flowchart illustrating an example of processing of the transmission device according to the first embodiment.

FIG. 8 is a supplemental view illustrating an example of processing of the transmission device according to the first embodiment.

FIG. 9 is a flowchart illustrating an example of processing of the drone according to the first embodiment.

FIG. 10 is a diagram illustrating a drone control system according to a second embodiment.

FIG. 11 is a block diagram illustrating a transmission device according to the second embodiment.

FIG. 12 is a block diagram illustrating an input device according to the second embodiment.

FIG. 13 is a view illustrating a display example of a display unit for notification of a setting state of a remote control mode according to the second embodiment.

FIG. 14 is a flowchart illustrating an example of processing of the transmission device and the input terminal according to the second embodiment.

FIG. 15 is a diagram illustrating a drone control system according to a third embodiment.

FIG. 16 is a diagram illustrating a control server (base station) according to the third embodiment.

FIG. 17 is a diagram illustrating a drone control system according to a fourth embodiment.

FIG. 18 is a diagram illustrating a drone control system according to a fifth embodiment.

FIG. 19 is a block diagram illustrating a drone according to the fifth embodiment.

FIG. 20 is a flowchart illustrating an example of processing of a transmission device according to the fifth embodiment.

FIG. 21 is a flowchart illustrating an example of an operation of step S1012 in FIG. 20.

FIG. 22 is a flowchart illustrating an example of a processing flow of the drone according to the fifth embodiment.

### MODE FOR CARRYING OUT THE INVENTION

Hereinafter, embodiments of the present disclosure will be described in detail with reference to the drawings. In one or more embodiments described in the present disclosure, components included in each of the embodiments can be combined with each other, and the combined resultant also forms part of the embodiments described in the present disclosure.

### First Embodiment

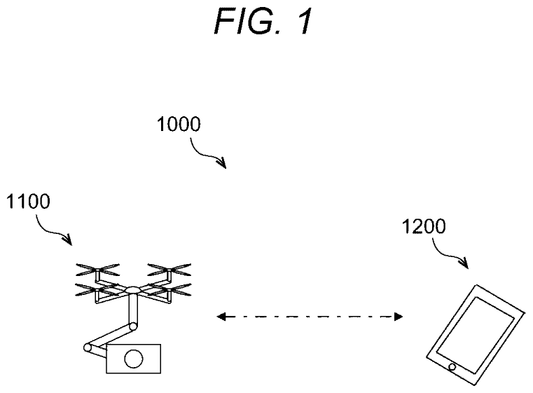

FIG. 1 illustrates a drone control system 1000 as a control system according to an embodiment of the present disclosure.

The drone control system 1000 includes a drone 1100 and a transmission device 1200. The drone 1100 is an unmanned aerial vehicle (mobile object) that is remotely operated in response to a control signal from the transmission device 1200. The transmission device 1200 is an operation device that operates the drone 1100 by an operator.

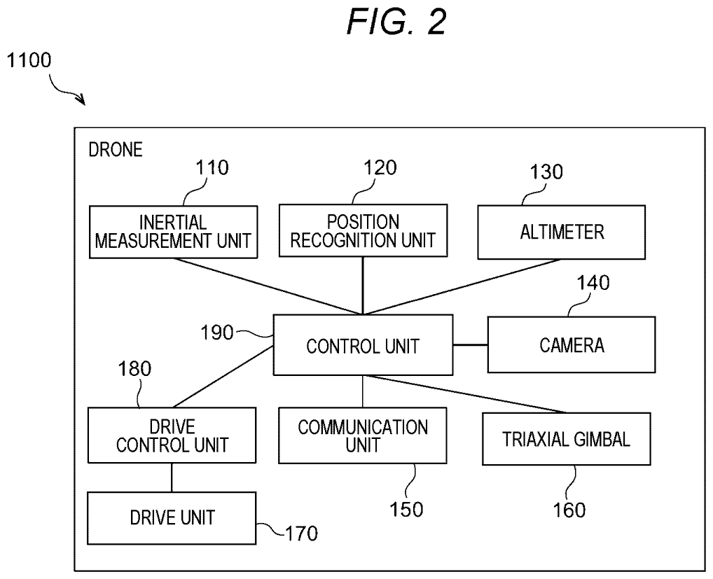

FIG. 2 is a block diagram of the drone 1100.

The drone 1100 includes an inertial measurement unit 110, a position recognition unit 120, an altimeter 130, a camera 140, a communication unit 150, a triaxial gimbal 160, a drive unit 170, a drive control unit 180, and a control unit 190.

Then inertial measurement unit 110 detects three-dimensional inertial motion (translational motion and rotational motion in three orthogonal axes directions) of drone 1100. The inertial measurement unit 110 detects inertial motion at regular time intervals, for example. The inertial measurement unit 110 is, for example, an inter measurement unit (IMU). In this case, the inertial measurement unit 110 detects the translational motion by an acceleration sensor and the rotational motion by a gyro sensor. The inertial measurement unit 110 provides information (inertia information) indicating the detected inertial motion to the control unit 190.

The position recognition unit 120 detects the position of the drone 1100. For example, the position recognition unit 120 detects the position of the drone 1100 at regular time intervals. The position recognition unit 120 is, for example, a global positioning satellite (GPS, Global Positioning System). The position recognition unit 120 is used to measure a position on the earth (current position) of the drone 1100. The position recognition unit 120 provides position information indicating the detected position to the control unit 190.

The altimeter 130 detects the altitude of the drone 1100. The altimeter 130 detects the altitude, for example, at regular time intervals. The altimeter 130 transmits altitude information indicating the detected altitude to the control unit 190.

The camera 140 is an imaging device that captures an image of an environment (for example, a landscape) around the drone 1100. The camera 140 may be any camera such as an RGB camera, a monochrome camera, an infrared camera, a stereo camera, or a depth camera as long as the camera can capture the image of the surrounding environment. By transmitting image data captured during the flight of the drone 1100 to the transmission device 1200 gripped or worn by an operator who is a user of the present control system, the operator can recognize the state of the surrounding environment viewed from the drone 1100. The image data acquired by the camera 140 may be a moving image or a still image.

The camera 140 is provided on the drone 1100 via the triaxial gimbal 160. The imaging direction of the camera, that is, the posture of the camera 140 can be changed by controlling the triaxial gimbal 160. The posture of the camera 140 can be controlled from the transmission device 1200 by an operator. In the transmission device 1200, it is possible to execute/activate or not execute/deactivate a remote control mode that enables the posture of the camera 140 to be controlled. That is, it is possible to switch between the remote control mode in which the posture of the camera 140 can be remotely controlled and a non-remote control mode in which the camera 140 cannot be remotely controlled. It is possible to remotely control the posture of the camera 140 during at least part of a period during which the remote control mode is being executed/activated. As an example, the transmission device 1200 executes/activates the remote control mode in a case where a predetermined operation (first user operation) is performed by the user who is the operator, and does not execute/deactivates the remote control mode in a case where a predetermined operation (second user operation) is performed.

The communication unit 150 performs wireless communication with the transmission device 1200. The communication unit 150 includes a circuit that processes a communication protocol, an AD/DA converter, a frequency converter, a band-pass filter, an amplifier, an antenna, and the like. Note that a form in which the communication unit 150 is connected to the transmission device 1200 by wire is also not excluded.

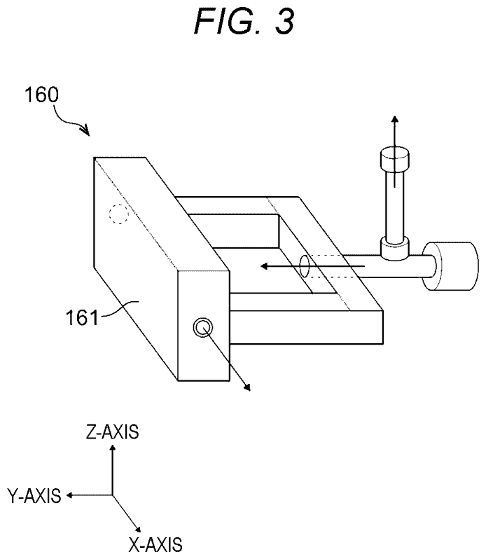

FIG. 3 schematically illustrates the appearance of the triaxial gimbal 160 according to an embodiment of the present disclosure.

The triaxial gimbal 160 is a stabilization device that controls the posture of the camera 140 and stabilizes the posture. The triaxial gimbal 160 is attached to a main body of the drone 1100 and supports the camera 140 attached to a mounting surface 161. The triaxial gimbal 160 includes a gyro having a degree of freedom of 3 in which three gimbal axes of an X-axis, a Y-axis, and a Z-axis intersect each other at a right angle. The triaxial gimbal 160 uses a gyroscope to maintain or stabilize the posture of the camera 140 so that it is not affected by external vibrations, particularly vibrations of the drone 1100 during flight.

By controlling the three gimbal axes of the triaxial gimbal 160, it is possible to control the imaging direction of the camera 140, that is, the posture of the camera 140. For example, in a case where it is desired to change the imaging direction (posture) of the camera 140, the posture of the triaxial gimbal 160 can be changed by controlling the corresponding gimbal axis among the three gimbal axes. Thus, the posture of the camera 140 provided via the triaxial gimbal 160, that is, the imaging direction can be changed.

The drive unit 170 includes a motor and a propeller. The propeller is a plurality of rotors arranged radially from the center of a fuselage or the center of gravity of the fuselage. The drive control unit 180 drives the motor to rotate the propeller. The drive control unit 180 controls the flight of the drone by controlling the rotation speed (rotation speed) of each rotary blade. It is possible to raise or lower the drone 1100 by increasing or decreasing the rotation speed (rotation speed) of the rotary blade. The drone 1100 can be moved forward, backward, or swung by inclining the fuselage with a difference in the rotation speed of each rotary wing. In the present embodiment, three or more rotor blades are provided in order to stabilize the posture of the drone in flight, but the number of rotor blades may be two or less.

The drive control unit 180 controls the rotation speed (rotation number) of each motor in the drive unit 170. The drive control unit 180 is, for example, an electric speed controller (ESC), and controls the rotation speed of each rotary blade by controlling a motor connected to each rotary blade of the drive unit 170.

The control unit 190 is a control device that controls the entire drone 1100. The control unit 190 controls other elements in the drone 1100. For example, the control unit 190 controls the posture of the camera 140 via the triaxial gimbal 160 on the basis of the control signal of camera remote control received from the transmission device 1200. The control unit 190 transmits the image data acquired by the camera 140 to the transmission device 1200 via the communication unit 150. Furthermore, the control unit 190 transmits at least one of the position information, the altitude information, or the inertia information of the drone 1100 to the transmission device 1200 via the communication unit 150.

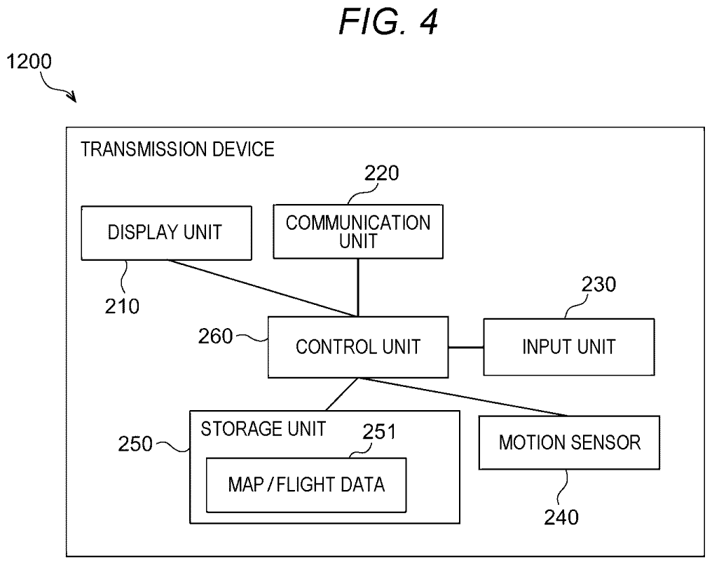

FIG. 4 is a block diagram of the transmission device 1200.

The transmission device 1200 is an operation device for operating the posture of the camera 140 of the drone 1100. The transmission device 1200 can be gripped or worn by an operator, for example. For example, the transmission device 1200 may be a terminal device such as a smartphone or a tablet device, or may be a device that can be worn on a body such as a head, such as a head mounted display.

The transmission device 1200 may be used to manually operate the flight of the drone 1100. In this case, the transmission device 1200 generates a control signal for the flight of the drone 1100 on the basis of the input operation of the operator, and transmits the control signal to the drone 1100. Alternatively, the transmission device 1200 may control the flight of the drone 1100 by transmitting a flight control signal to the drone 1100 on the basis of a flight plan. Alternatively, the flight of the drone 1100 may be controlled on the basis of a control signal from the base station.

Such a transmission device 1200 includes a display unit 210, a communication unit 220, an input unit 230, a motion sensor 240, and a storage unit 250.

The display unit 210 is a display device capable of displaying an image (captured image) based on the image data captured by the camera 140 of the drone 1100. The operator can recognize the surrounding environment viewed from the drone 1100 by viewing the captured image of the camera 140 displayed on the display unit 210. The display unit 210 can also display data other than the image data captured by the camera 140. The display unit 210 can display surrounding map data including the position of the drone 1100. Furthermore, the display unit 210 can also display notification information for notifying the operator (user) whether the remote control mode capable of remotely controlling the camera 140 of the drone 1100 is executed/activated or is not executed/deactivated.

The communication unit 220 is wirelessly connected to the drone 1100 and transmits and receives a radio signal to and from the drone 1100. The communication unit 220 includes a circuit that processes a communication protocol, an AD/DA converter, a frequency converter, a band-pass filter, an amplifier, an antenna, and the like. Note that a form in which the communication unit 220 is connected to the drone 1100 by wire is also not excluded.

The input unit 230 is an interface for the operator of the drone 1100 to input instructions, data, or the like. As an example, the input unit 230 includes at least one of a key or a button. The input unit 230 may be a software component provided on the touch panel (for example, at least one of a key or a button is displayed in a partial region of the touch panel), or may be a mechanical component attached to the main body of the transmission device 1200. The input unit 230 may include a contact sensor such as a fingerprint sensor. When the operator presses or touches (hereinafter, unified to pressing) the button, an operation signal corresponding to the pressing of the button is output to the control unit 260. Further, for example, when an upward direction key such as a cross key is pressed, an operation signal corresponding to the pressing of the upward direction key is output to the control unit 260.

The motion sensor 240 detects the posture of the transmission device 1200. The motion sensor 240 is, for example, a sensor combining sensors such as an acceleration sensor that detects three-dimensional motion and a gyro sensor that detects angular velocity. The motion sensor 240 outputs a sensing signal (detection signal) indicating the posture of the transmission device 1200 as posture information by sensing an operation applied to the transmission device 1200.

The storage unit 250 stores various data or information necessary for the operation of the control unit 260. The storage unit 250 includes, for example, a hard disk, a RAM disk, a nonvolatile memory, and the like.

The storage unit 250 stores data 251 such as map data and flight data. The map data is map data of an environment in which the drone 1100 flies. Data including the position of the drone 1100 and its surroundings in the map data may be displayable on the display unit 210. Information such as the position and altitude of the drone 1100 may be superimposed on the displayed map data. The flight data includes a flight path of the drone 1100. The flight path is a three-dimensional position, for example, a set of latitude, longitude, and altitude, arranged in time series. The control unit 260 can control the flight of the drone according to the flight data stored in the storage unit 250. Note that the flight data may include additional information such as the flight speed of each section and the time of arrival at a destination position, in addition to a flight route.

The control unit 260 is a control device that controls the entire transmission device 1200. The control unit 260 controls other elements included in the transmission device 1200. The control unit 260 causes the display unit 210 to display the image data, which is captured by the camera 140 of the drone 1100 and received by the communication unit 220, so that the captured image of the camera 140 can be displayed on the display unit 210.

The control unit 260 may acquire map data on the basis of, for example, a web mapping platform on the Internet through the communication unit 220 and display the map data on the display unit 210. The position information and the like of the drone 1100 may be superimposed on the map data displayed on the display unit 210.

The control unit 260 can switch execution/activation or non-execution/deactivation of the remote control mode of the camera 140 on the basis of an operation signal from the input unit 230. Furthermore, the control unit 260 can switch the display mode of the display unit 210 according to an operation signal from the input unit 230. For example, the control unit 260 may be capable of switching between a first display mode (imaging screen display mode) in which the captured image of the camera 140 is displayed and a second display mode (map display mode) in which surrounding map data including the current position of the drone 1100 is displayed. Alternatively, the control unit 260 may cause the transmission device 1200 to simultaneously execute both of these modes to display both the captured image and the map data. Detailed information such as altitude information, position information, and inertia information of the drone 1100 may be displayed together with the captured image or the map data.

The control unit 260 can notify the operator of a state of execution/activation or non-execution/deactivation of the remote control mode of the camera 140. As an example, the control unit 260 displays notification information indicating the state of the execution/activation or the non-execution/deactivation of the remote control mode on the display unit 210. The operator can check whether or not the remote control mode is executed/activated in real time by checking the notification information displayed on the display unit 210.

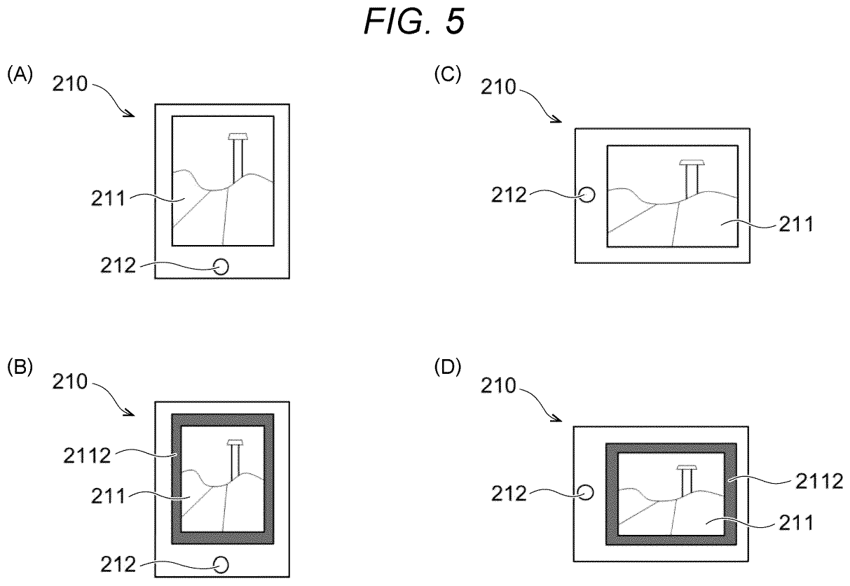

FIG. 5 is a diagram illustrating a display example of the notification information for notifying a state of execution/activation or non-execution/deactivation of the remote control mode on the display unit 210.

FIG. 5(A) illustrates a display example of the display unit 210 in a state where the remote control mode is in the non-execution/deactivation state. A captured image based on the image data acquired by the camera 140 is displayed on the display screen 211 of the display unit 210. A switch button 212, which is an example of the input unit 230, is provided on the display unit 210 or in the vicinity of the display unit 210. The switch button 212 may be a software component using a touch panel (for example, a button is displayed in a partial region of the touch panel) or a mechanical component attached to the main body of transmission device 1200. When the operator performs a predetermined operation (corresponding to an example of the first user operation) on the switch button 212, the remote control mode for the camera 140 can be executed/activated. Examples of the predetermined operation include pressing the switch button 212 for a predetermined time (threshold time) or longer, and pressing the switch button 212 a predetermined number of times within a predetermined time. In a case where the switch button 212 is pressed for a predetermined time or longer, it may be requested to continue pressing the switch button even after the remote control mode is executed/activated, and in a case where pressing for a predetermined time or longer is stopped (released), the remote control mode may be set to non-execution/deactivation. Alternatively, once the remote control mode is executed/activated, the execution/activation of the remote control mode may be maintained even when the finger is released from the switch button. In this case, it is only required that, in a case where an operation (second user operation) for setting the remote control mode to non-execution/deactivation is separately performed, the remote control mode is set to non-execution/deactivation. The second user operation may be any operation such as pressing the switch button 212 for a predetermined time (threshold time) or longer. The time length for pressing by the first user operation and the time length for pressing by the second user operation may be the same or different.

FIG. 5(B) illustrates a display example of the display screen 211 in a case where the remote control mode of the camera 140 is executed/activated. An edge image 2112 different from the captured image of the camera 140 is displayed in a peripheral region (edge) in the display screen 211. The edge image 2112 is, for example, an image of a predetermined color (for example, black). The edge image 2112 is notification information indicating that the remote control mode has been executed/activated. The display unit 210 functions as an output unit that outputs the notification information. The display area of the captured image of the camera 140 displayed in FIG. 5(A) is reduced by the edge image 2112. The edge image 2112 may be an image of a predetermined pattern instead of an image of a predetermined color. In addition, the display area of the captured image of the camera 140 may be reduced by displaying an image different from the captured image of the camera 140 as the notification information not at the edge in the display screen 211 but at another location. The operator can confirm that the remote control mode is executed/activated by visually recognizing the notification information.

In the examples of FIG. 5(A) and 5(B), the operator is notified that the remote control mode is executed/activated by reducing the display area of the image indicated by the image data of the camera 140. Conversely, by increasing the area of the image to be displayed, it may be notified that the remote control mode is executed/activated. In this case, for example, it may be notified that the remote control mode is not executed/deactivated by the display state of FIG. 5(B), and it may be notified that the remote control mode is executed/activated by the display state of FIG. 5(A). By changing the area of the captured image of the camera 140 displayed on the display screen 211 in this manner, it is possible to notify the operator of execution/activation or non-execution/deactivation of the remote control mode of the camera 140.

In FIG. 5(A) and 5(B), the orientation of the display screen 211 of the transmission device 1200 is vertical, but FIG. 5(C) and 5(D) illustrate display examples of the display unit 210 in a case where the orientation of the display screen 211 of the transmission device 1200 is horizontal. FIG. 5(C) illustrates a display example in a case where the remote control mode of the camera 140 is set to non-execution/deactivation, and FIG. 5(D) illustrates a display example in a case where the remote control mode of the camera 140 is executed/activated. FIG. 5(C) and 5(D) are the same as FIG. 5(A) and 5(B) except that the orientation of the display screen 211 is different, and thus, description thereof will be omitted.

After the remote control mode of the camera 140 is executed/activated, the operator performs the predetermined operation (second user operation) on the switch button 212 to end the remote control mode. That is, the remote control mode is switched from the state of execution/activation to the state of non-execution/deactivation. Examples of the predetermined operation include releasing a finger pressing or touching the switch button 212 from pressing or touching, pressing for a predetermined time (threshold time) or longer, and pressing the switch button 212 a predetermined number of times within a predetermined time.

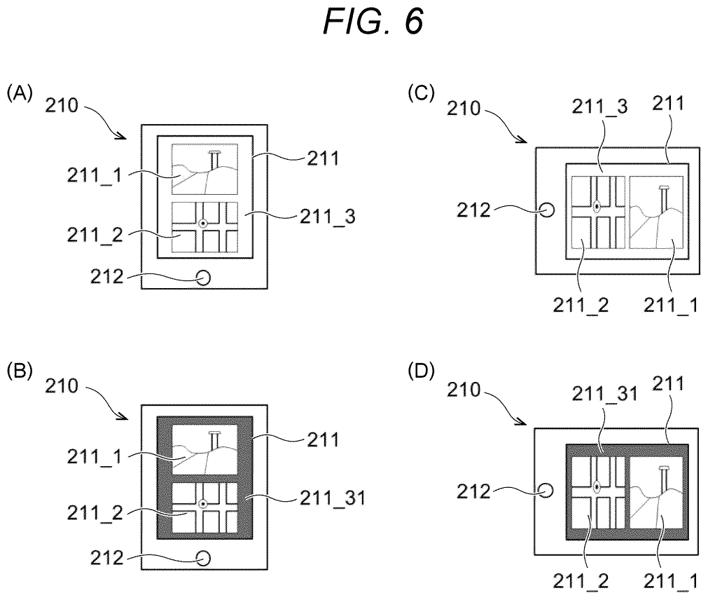

FIG. 6 illustrates another display example of the notification information for notifying the state of the execution/activation execution or the non-execution/deactivation of the remote control mode on the display unit 210.

FIG. 6(A) illustrates a display example of the display unit 210 in a state where the remote control mode is in the non-execution/deactivation state. The display screen 211 of the display unit 210 includes a display region 211_1 that displays a captured image based on image data captured by the camera 140, and a display region 211_2 that displays a surrounding map including the position of the drone 1100. The display region 211_1 and the display region 211_2 are arranged in the vertical direction. The display screen 211 includes a background region 211_3 other than the display region 211_1 and the display region 211_2. The background region 211_3 may be an application screen, a home screen, or any other screen. The operation of executing/activating or not executing/deactivating the remote control mode by the switch button 212 may be similar to the case of FIG. 5.

FIG. 6(B) illustrates a display example of the display screen 211 in a case where the remote control mode of the camera 140 is executed/activated. An image 211_31 of a predetermined color (for example, black) is displayed in the background region 211_3. The image 211_31 is notification information indicating that the remote control mode has been executed/activated. The display unit 210 functions as an output unit that outputs the notification information. By displaying the image 211_31, the operator can recognize that the remote control mode has been executed/activated. The image displayed in the background region 211_3 may be, instead of an image of a predetermined color, an image of a predetermined pattern, or may be another type of image (for example, a blinking image or the like).

FIG. 6(C) and 6(D) illustrate display examples of the display unit 210 in a case where the display screen 211 of the transmission device 1200 is horizontally oriented. In a case where the display screen 211 is horizontally oriented, the display region 211_1 and the display region 211_2 are displayed side by side on the display screen 211, and the other region is the background region 211_3. FIG. 6(C) illustrates a display example in a case where the remote control mode of the camera 140 is set to non-execution/deactivation, and FIG. 6(D) illustrates a display example in a case where the remote control mode of the camera 140 has been executed/activated. FIG. 6(C) and 6(D) are the same as FIG. 6(A) and 6(B) except that the orientation of the display screen 211 is different, and thus, description thereof will be omitted.

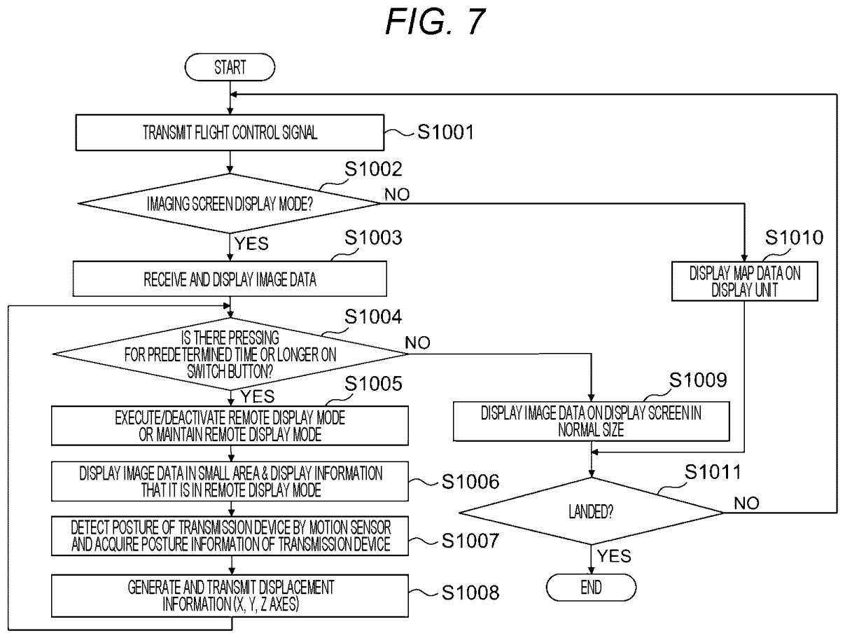

FIG. 7 is a flowchart illustrating an example of processing of the transmission device 1200 in the drone control system 1000. A situation is assumed in which the operator grips the transmission device 1200 and controls the orientation (posture) of the camera 140 while viewing the captured image of the camera 140 on the display unit 210.

The transmission device 1200 transmits a control signal (flight control signal) of the flight of the drone 1100 on the basis of the flight plan or the operator's input (S1001).

The control unit 260 of the transmission device 1200 determines whether or not the imaging screen display mode for displaying the image data captured by the camera 140 of the drone 1100 on the display unit 210 is executed/activated (S1002).

In a case where the imaging screen display mode is not executed/activated, the control unit 260 causes the display unit 210 to display the surrounding map data including the position of the drone 1100 (S1010).

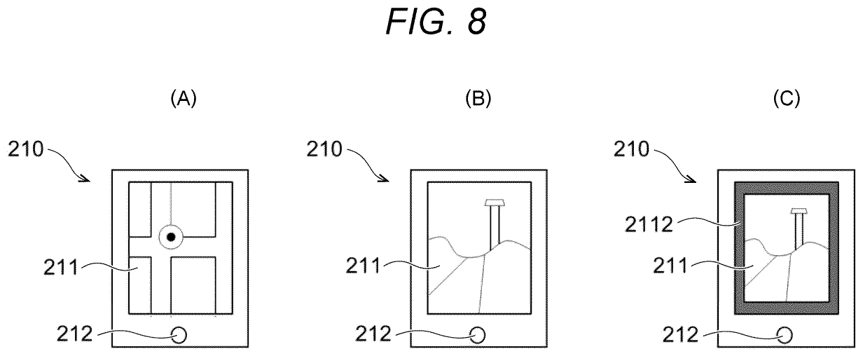

FIG. 8(A) illustrates an example in which the map data including the position of the drone 1100 is displayed on the display unit 210 in a case where the imaging screen display mode is not executed/activated.

After step S1010, the control unit 260 determines whether or not the drone 1100 has landed (S1011). In a case where the drone has landed, the process ends. In a case where the drone has not landed, the process returns to step S1001.

In a case where the imaging screen display mode is executed/activated, the control unit 260 receives and displays the image data of the camera 140 received from the drone 1100 via the communication unit 220 (S1003).

The control unit 260 determines whether or not the switch button 212 is pressed for a predetermined time or longer (S1004). That is, the control unit 260 determines whether or not an instruction to execute/activate the remote control mode of the camera 140 has been input from the operator. In a case where the switch button 212 is not pressed for the predetermined time or longer, the control unit 260 determines that the instruction to execute/activate the remote control mode of the camera 140 is not input. Alternatively, in a case where the switch button 212 is not pressed for the predetermined time or longer, the control unit 260 determines that an instruction to set the remote control mode to non-execution/deactivation has been input, and sets the remote control mode to non-execution/deactivation. That is, even after the switch button 212 is pressed for the predetermined time or longer and the remote control mode is executed/activated, if there is no pressing for a predetermined time or longer, the control unit 260 ends the remote control mode. The predetermined time required in a case of executing/activating the remote control mode and the predetermined time required in a case of executing/activating the remote control mode do not need to be the same. In a case where the remote control mode is to be set to non-execution/deactivation, the remote control mode may be set to non-execution/deactivation by detecting that the finger has moved away from the switch button 212.

In a case where there is no pressing for the predetermined time or longer, that is, in a case where the remote control mode is set to non-execution/deactivation, the control unit 260 sets the captured image of the camera 140 displayed on the display unit 210 to a normal size (initial size) (S1009). For example, the captured image of the camera 140 is displayed in the entire display screen 211 or in a predetermined size.

FIG. 8(B) illustrates an example of the captured image of the camera 140 displayed on the display screen 211 of the display unit 210 in a case where the remote control mode is set to non-execution/deactivation. The captured image of the camera 140 is displayed in a normal size (in this example, on the entire display screen 211). Note that FIG. 8(B) is the same as FIG. 5(A).

After step S1009, the control unit 260 determines whether the drone 1100 has landed (S1011). In a case where the drone has landed, the process ends. In a case where the drone has not landed, the process returns to step S1001.

In a case where there is pressing for the predetermined time or longer, the control unit 260 executes/activates the remote control mode of the camera 140 (S1005). In a case where the remote control mode has already been executed/activated, the remote control mode is maintained.

The control unit 260 changes the edge portion of the captured image of the camera 140 displayed on the display unit 210 to the edge image 2112 of a predetermined color (see FIG. 5) (same step S1005). By setting the edge portion to the edge image 2112 of the predetermined color, the display area (display size) of the captured image of the camera 140 becomes smaller than the normal size displayed in step S1009. By visually recognizing the edge image 2112 or by visually recognizing that the display size of the captured image has decreased, the operator recognizes that the remote control mode is executed/activated. The edge image 2112 functions as notification information for notifying the operator that the remote control mode is executed/activated.

FIG. 8(C) illustrates a display example of the display unit 210 in a case where the remote control mode is executed/activated. The edge portion of the captured image of the camera 140 is changed to the edge image 2112. FIG. 8(C) is the same as FIG. 5(B).

The motion sensor 240 detects the posture of the transmission device 1200, and the control unit 260 acquires the posture information of the transmission device 1200 detected by the motion sensor 240 (S1007).

The control unit 260 generates a control signal (posture control signal) for controlling the posture of the camera 140 on the basis of the acquired posture information of the transmission device 1200, and transmits the generated posture control signal to the drone 1100 (S1008). More specifically, the control unit 260 generates displacement information indicating a displacement of the three gimbal axes of the X-axis, the Y-axis, and the Z-axis of the triaxial gimbal 160, and transmits the generated displacement information to the drone 1100 (S1008). After the control unit 260 transmits the displacement information, the process returns to step S1004, and steps S1004 to S1008 are repeated while the remote control mode is executed/activated. A method of setting the correspondence relationship between the posture of the transmission device 1200 and the posture of the camera 140 (displacement information of the gimbal axis) will be described later.

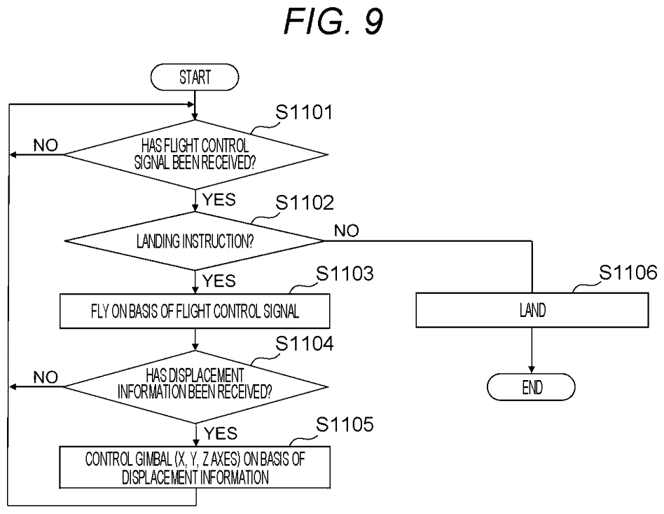

FIG. 9 is a flowchart illustrating an example of processing of the drone 1100 in the drone control system 1000.

The control unit 190 of the drone 1100 receives the flight control signal transmitted from the transmission device 1200 via the communication unit 150 (S1101).

The control unit 190 determines whether or not the received flight control signal is a landing instruction (S1102). In a case where the instruction is not the landing instruction, the process proceeds to step S1103, and in a case where the instruction is the landing instruction, the process proceeds to step S1106.

In a case where the flight control signal is the landing instruction, the control unit 190 causes the drone 1100 to land (S1106).

In a case where the flight control signal is not the landing instruction, the control unit 190 performs control to continue the flight of the drone 1100 on the basis of the flight control signal (S1103).

The control unit 190 determines whether the posture control signal (here, gimbal displacement information) for controlling the posture of the camera 140 is received from the transmission device 1200 (S1104).

In a case where the displacement information is received, the control unit 190 calculates displacements of the three gimbal axes, that is, the X-axis, the Y-axis, and the Z-axis of the triaxial gimbal 160 on the basis of the received displacement information. The control unit 190 controls the triaxial gimbal 160 on the basis of the calculated displacement of the gimbal axis (S1105). Thus, the posture of the camera 140 is controlled. Thereafter, the process returns to step S1101.

A method of setting a correspondence relationship between the posture of the transmission device 1200 and the posture of the camera 140 (displacement information of the gimbal axis) will be described.

As a first example, the control unit 260 of the transmission device 1200 acquires the posture information of the camera 140 and the posture information of the transmission device 1200 at the time when the remote control mode is executed/activated. The control unit 260 detects a difference between both the postures on the basis of both the posture information. The control unit 260 generates a posture control signal (displacement information) for controlling the posture of the camera 140 on the basis of the difference and the posture information of the transmission device 1200. For example, the control unit 260 generates a posture control signal (displacement information) by adding the difference to the posture information of the transmission device 1200. As a result, for example, even in a state where the operator is lying down while holding the transmission device 1200, it is possible to easily control the posture of the camera 140 by executing/activating the remote control mode. As described above, in the present method, the posture control of the camera 140 can be performed while allowing inconsistency between the posture of the camera 140 (the orientation of the gimbal mechanism) and the posture of the transmission device 1200.

As a second example, the posture of the camera 140 (the orientation of the gimbal mechanism) and the posture of the transmission device 1200 may be made to coincide with each other. The transmission device 1200 receives the posture information of the camera 140 from the drone. The control unit 260 of the transmission device 1200 detects a difference between the posture of the camera 140 and the posture of the transmission device 1200 on the basis of the posture information of the camera 140 and the posture information of the transmission device 1200 (operation device). In order to detect the difference, the camera 140 and the transmission device 1200 may use a common coordinate system, or may have a correspondence relationship with each other on the basis of the difference in the coordinate system while using different coordinate systems. The control unit 260 of the transmission device 1200 executes/activates the remote control mode in a case where the detected difference satisfies a condition. That is, in step S1005 of FIG. 8, in a case where the switch button is pressed for the predetermined time or longer and the difference satisfies the condition, the remote control mode is executed/activated. An example of the condition is that the difference may become equal to or less than a threshold or zero. This makes it possible to link the posture of the camera 140 and the posture of the transmission device 1200, and the operator can easily control the posture of the camera 140. Since the operator cannot control the posture of the camera 140 until the difference becomes equal to or less than the threshold, the operator may perform work such as directing the transmission device 1200 in various directions until the difference becomes equal to or less than the threshold.

As described above, according to the present embodiment, the posture of the camera 140 of the drone 1100 or the triaxial gimbal 160 can be controlled (remotely controlled) by controlling the posture (orientation or the like) of the transmission device 1200 such as inclining the transmission device 1200 gripped by the operator. Therefore, the operator can easily control the posture of the camera 140 of the drone 1100 while taking a free posture. Furthermore, by outputting notification information indicating the execution/activation execution or non-execution/deactivation of the remote control mode to the display unit 210 of the transmission device 1200, the operator can easily grasp whether or not the transmission device 1200 can remotely control the posture of the camera 140. In particular, by notifying the operator of the execution/activation or the non-execution/deactivation of the remote control mode by changing the area for displaying the captured image of the camera 140 displayed on the display unit 210, the operator can easily determine the execution/activation or the non-execution/deactivation of the remote control mode in real time. For example, the operator can determine that the remote control mode is executed/activated when the display size of the captured image of the camera 140 is small, and that the remote control mode is not executed/deactivated when the display size is large.

### Second Embodiment

In the second embodiment, the motion sensor and the operation input function of the transmission device in the first embodiment are independently configured as an input terminal. The input terminal and the transmission device can communicate with each other, and the transmission device and the drone can communicate with each other. The operator operates the input terminal to input various instructions to the drone 1100, and an instruction signal is transmitted to the transmission device. The instruction signal includes, for example, posture information detected by the motion sensor or a posture control signal based on the posture information. In addition, the instruction signal includes, for example, a signal indicating that the button is pressed. The functions of the transmission device other than the functions transferred to the input terminal are similar to those of the first embodiment. In this manner, the operator can perform gimbal control of the drone 1100, that is, posture control of the camera, using the input terminal.

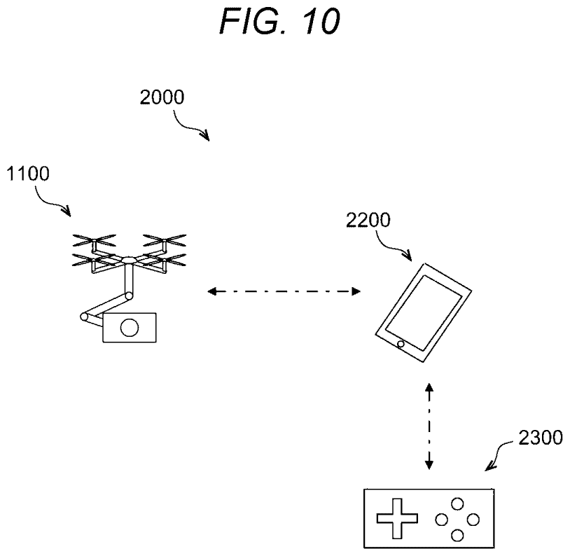

FIG. 10 illustrates a drone control system 2000 according to an embodiment of the present disclosure. Components similar to those of the first embodiment will be denoted by the same reference signs, and detailed description thereof will be omitted. The drone control system 2000 includes a drone 1100, a transmission device 2200, and an input terminal 2300.

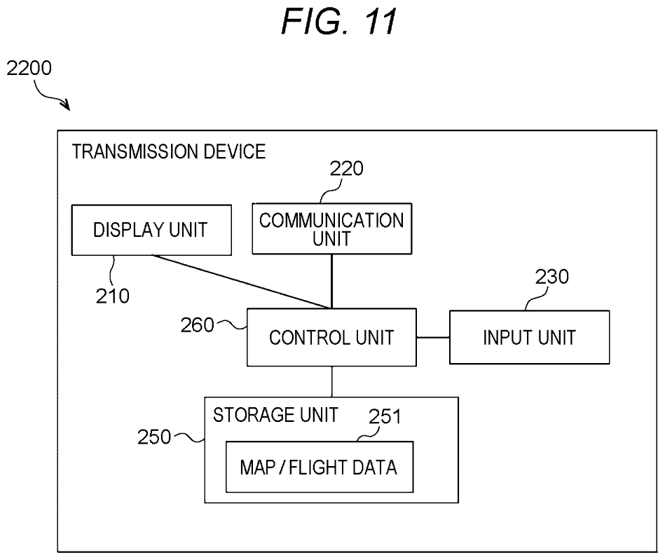

FIG. 11 is a block diagram of the transmission device 2200. The transmission device 2200 can wirelessly communicate with the drone 1100, and generates a flight control signal, a posture control signal (displacement information), or the like on the basis of an instruction signal from the input terminal 2300 and transmits the signal to the drone 1100. The transmission device 2200 is connected to the input terminal 2300 in a wired or wireless manner, and can receive an instruction signal from the input terminal 2300. As in the first embodiment, the transmission device 1200 includes the display unit 210, the communication unit 220, the input unit 230, and the storage unit 250. The operation of each element is similar to that of the first embodiment.

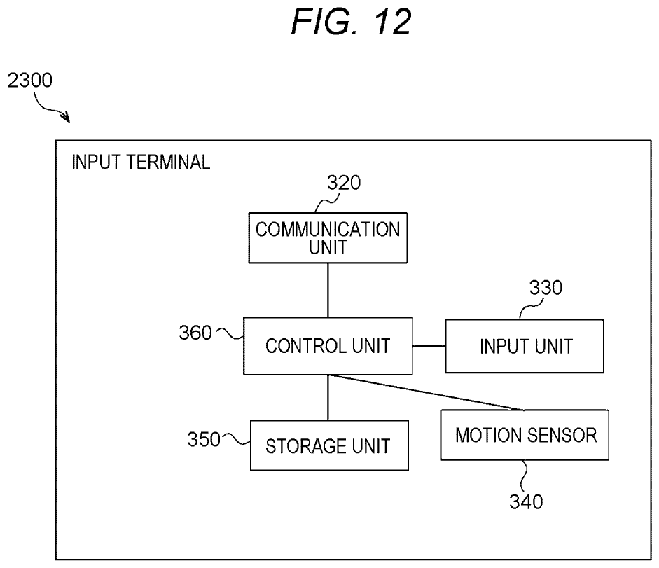

FIG. 12 is a block diagram of the input terminal 2300.

The input terminal 2300 is an operation device that receives an instruction input from an operator and outputs an instruction signal to the transmission device 2200. The input terminal 2300 controls the posture of the camera 140 in the drone 1100 via the transmission device 2200.

The input terminal 2300 includes a communication unit 320, an input unit 330, a motion sensor 340, a storage unit 350, and a control unit 360.

The communication unit 320 is connected to the transmission device 2200 in a wireless or wired manner, and performs wireless or wired communication with the transmission device 2200. In this example, a case where it is wireless is assumed. In this case, the communication unit 320 includes, for example, a circuit that performs processing of a communication protocol, an AD/DA converter, a frequency converter, a band-pass filter, an amplifier, an antenna, and the like.

The input unit 330 is a key, a button, or the like provided in the input terminal 2300. The input unit 330 is similar to the input unit 230 in the transmission device 1200 of the first embodiment, and detailed description thereof will be omitted.

The motion sensor 340 senses the posture of the input terminal 2300 and acquires posture information. The motion sensor 340 is similar to that in the first embodiment, and thus description thereof will be omitted.

The storage unit 350 stores various data or information necessary for the operation of the control unit 360. The storage unit 350 includes, for example, a hard disk, a RAM disk, a nonvolatile memory, and the like.

The control unit 360 is a control device that controls the entire input terminal 2300. The control unit 360 controls other elements in the input terminal 2300. The control unit 360 executes/activates a remote control mode of the camera 140 when detecting a predetermined operation to the input unit 330 (a button or the like), for example, pressing of a button for a predetermined time or longer on the basis of an instruction signal received from the input terminal 2300. While the remote control mode is being executed/activated, the control unit 360 acquires a detection signal (posture information) indicating the posture of the input terminal 2300 from the motion sensor 340, and transmits a posture control signal (displacement information) based on the posture information to the transmission device 2200 via the communication unit 320. Note that the control unit 360 may store the acquired posture information or displacement information in the storage unit 350 in time series.

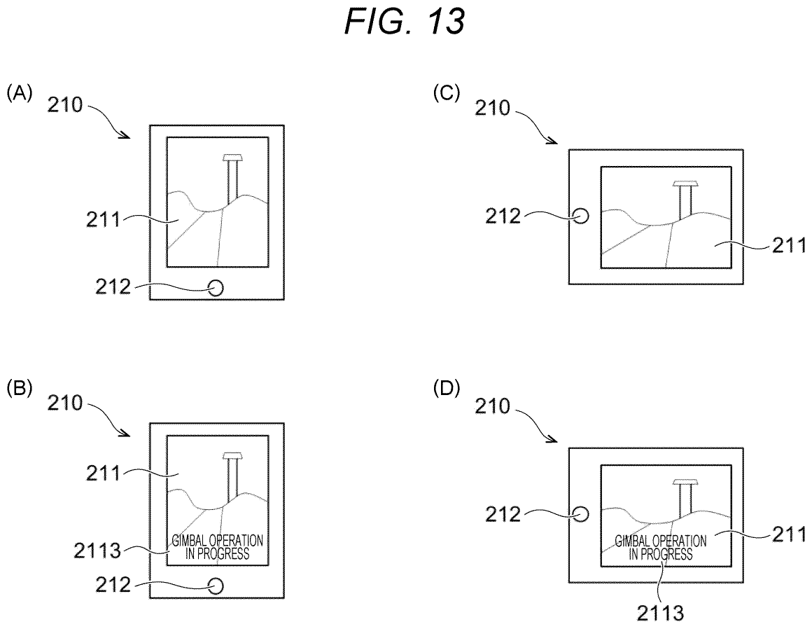

FIG. 13 illustrates a display example of the display unit 210 of the transmission device 2200 for notification information for notifying a state of execution/activation or non-execution/deactivation of the remote control mode. A difference from FIG. 5 used in the first embodiment will be mainly described.

FIG. 13(A) is the same as FIG. 5(A). FIG. 13(B) illustrates a display example of the display unit 210 in a case where the remote control mode is executed/activated. In the first embodiment, the peripheral region in the display screen 211 is an image of a predetermined color, but in FIG. 13(B), a text 2113 of “gimbal operation in progress” is superimposed on the captured image of the camera 140 displayed in the display screen 211. The text 2113 functions as notification information for notifying the operator that the remote control mode is executed/activated. The display size of the captured image of the camera 140 is reduced by the region where the text 2113 is superimposed. The operator can easily determine the remote control mode in real time by viewing “gimbal operation in progress”. Note that the contents of the text to be displayed may be different contents as long as the remote control mode can be intuitively determined. The display method of the text 2113 is not limited to the method of superimposing the text on the image data. For example, a part of the captured image displayed on the display screen 211 may be deleted, and an image including the text 2113 may be displayed in the deleted part. Furthermore, an icon may be used instead of the text.

FIG. 13(C) and 13(D) are similar to FIG. 13(A) and 13(B) except that the display unit 210 of the transmission device 2200 is horizontally oriented, and thus description thereof will be omitted.

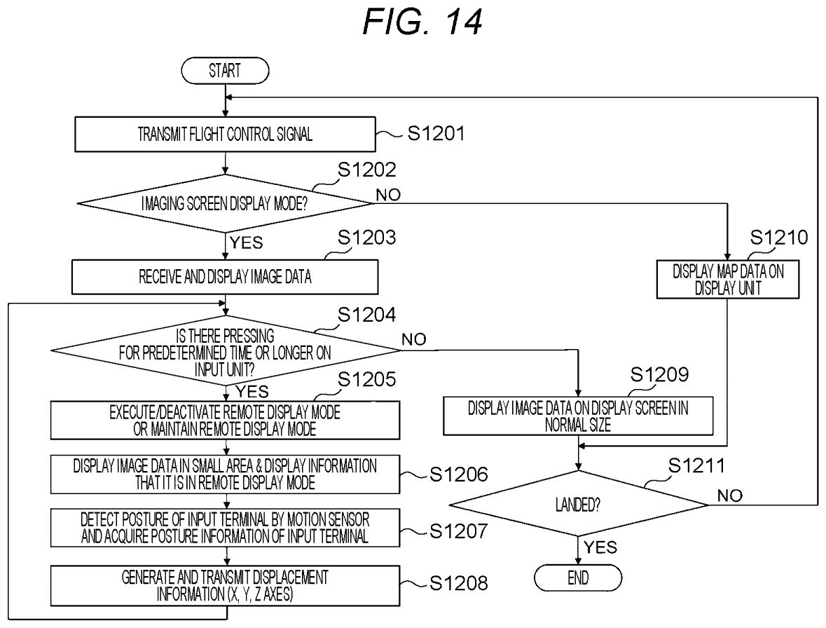

FIG. 14 is a flowchart illustrating an example of processing of the transmission device 2200 and the input terminal 2300 in the drone control system 2000. The description of the same processing as that of the first embodiment will be omitted or simplified as appropriate.

The transmission device 2200 transmits a flight control signal to the drone 1100 on the basis of the flight plan or the operator's input (S1201).

The control unit 260 determines whether the display mode of the display unit 210 is a captured image display mode (S1202).

In a case where the captured image display mode is not set, surrounding map data including the position of the drone 1100 is displayed on the display unit 210 (S1210). The control unit 260 determines whether the drone 1100 has landed (S1211). In a case where the drone has landed, the process ends. In a case where the drone has not landed, the process returns to S1201.

In a case where it is in the captured image display mode, the control unit 260 receives the image data of the camera 140 from the drone 1100 via the communication unit 220, and displays the captured image on the basis of the image data (S1203).

On the basis of the instruction signal from the input terminal 2300, the control unit 260 determines whether a predetermined operation (here, pressing of the button for a predetermined time or longer) has been performed on the input unit 330 of the input terminal 2300 (S1204).

In a case where there is no pressing for the predetermined time or longer, the captured image is displayed in a normal size on the display unit 210 (S1209). For example, the captured image is displayed on the entire display screen 211 or a predetermined region in the display screen 211. The control unit 260 determines whether the drone 1100 has landed (S1211). In a case where the drone has landed, the process ends. In a case where the drone has not landed, the process returns to S1201.

In a case where there is pressing for a predetermined time or longer, the control unit 260 executes/activates a remote control mode for the camera 140 (S1205). In a case where the remote control mode has already been executed/activated, the remote control mode is maintained.

The control unit 260 superimposes a text indicating that the remote control mode is executed/activated on the captured image of the camera 140 displayed on the display unit 210 (same step S1005). By superimposing the text, the display size of the captured image is reduced by the display size of the text. The text functions as the notification information for notifying the operator that the remote control mode is executed/activated.

The motion sensor 240 senses (detects) the posture of the input terminal 2300 and transmits posture information to the transmission device 2200 (S1207). The control unit 260 of the transmission device 2200 receives the posture information detected by the motion sensor 240 from the input terminal 2300 (same step S1207).

The control unit 260 generates a control signal (posture control signal) for controlling the posture of the camera 140 on the basis of the acquired posture information of the input terminal 2300, and transmits the generated posture control signal to the drone 1100 (S1208). More specifically, the control unit 260 generates displacement information indicating a displacement of the three gimbal axes of the X-axis, the Y-axis, and the Z-axis of the triaxial gimbal 160, and transmits the generated displacement information to the drone 1100 (S1208). After the control unit 260 transmits the displacement information, the process returns to step S1204, and steps S1204 to S1208 are repeated while the remote control mode is executed/activated.

Processing of the drone 1100 is similar to that in the first embodiment, and thus description thereof will be omitted.

As described above, according to the present embodiment, an input terminal for operation is prepared separately from the transmission device, and the operator controls the posture of the input terminal, so that the operator can more easily control the posture of the camera 140.

### Third Embodiment

A third embodiment is a control system that controls a drone via a control server that is a base station. This enables flight control of the drone and posture control of the camera even in a case where, for example, the drone is present in a far place where the operator cannot see the drone and cannot communicate with the drone directly from the transmission device, for example. Hereinafter, the present embodiment will be described in detail. Note that components similar to those of the first embodiment or the second embodiment are denoted by the same reference signs, and description thereof will be omitted as appropriate.

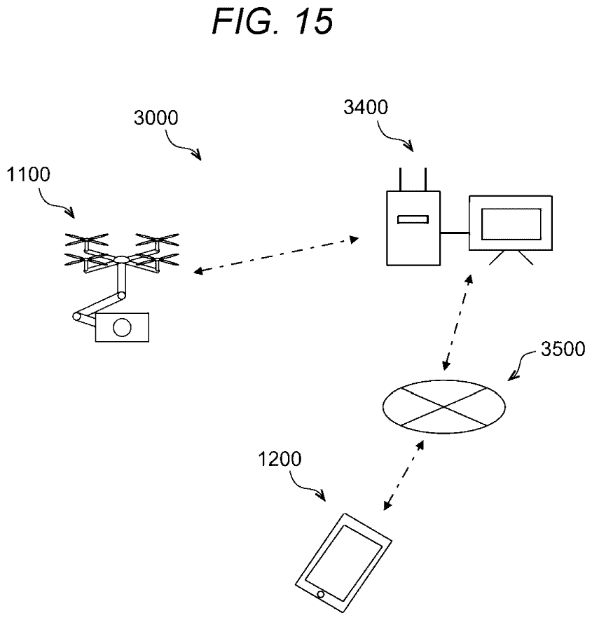

FIG. 15 illustrates a drone control system 3000 according to the embodiment of the present disclosure. The drone control system 3000 includes the drone 1100, the transmission device 1200, a control server 3400, and a network 3500.

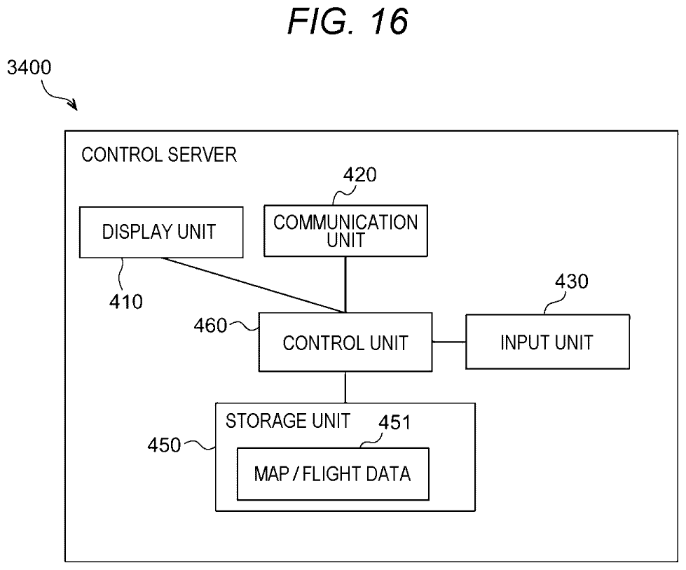

FIG. 16 is a block diagram of the control server 3400. The control server 3400 includes a display unit 410, a communication unit 420, an input unit 430, a storage unit 450, and a control unit 460. The control server 3400 relays communication between the transmission device 1200 and the drone 1100. The control server 3400 may be operated by a surveillance staff who monitors the flight of the drone 1100.

The communication unit 420 wirelessly communicates with the drone 1100 and the transmission device 1200. The communication unit 420 includes a circuit that processes a communication protocol, an AD/DA converter, a frequency converter, a band-pass filter, an amplifier, an antenna, and the like. The communication unit 420 may include separate communication interfaces for the drone 1100 and for the transmission device 1200. The communication unit 420 is connected to the network 3500 in a wired or wireless manner, and communicates with the transmission device 1200 via the network 3500. The network 3500 may be a wide area network or a local network. In addition, the network 3500 may be a public network or a non-public network.

The display unit 410 displays a screen for monitoring the drone 1100. The surveillance staff monitors the drone 1100 through this screen. On the screen, an image (captured image) indicated by image data captured by the camera 140 of the drone 1100, a flight state (flight position, remaining battery amount, weather, presence/absence of surrounding obstacle, and the like) of the drone 1100, or the like may be displayed. The number of drones to be monitored may be plural.

The input unit 430 is an interface for an operation input by the surveillance staff. For example, the surveillance staff may input a message to be transmitted to the operator to the transmission device 1200. For example, a message indicating the situation of the drone 1100, for example, in a case where the drone 1100 collides with a building or the like, a message about the collision may be transmitted to the transmission device 1200. Alternatively, the surveillance staff may operate the drone 1100 using the input unit 430 instead of the operator of the transmission device 1200 in an emergency. Alternatively, the surveillance staff or another operator may control the flight of the drone 1100 using the input unit 430, and the transmission device 1200 may display the captured image of the camera 140 and instruct posture control of the camera 140. Furthermore, a surveillance staff or another operator may input a flight plan to the drone 1100 using the input unit 430, and the control unit 460 may transmit a flight control signal based on the flight plan to the drone 1100.

The storage unit 450 stores various data or information necessary for the operation of the control unit 460. The storage unit 450 includes, for example, a hard disk, a RAM disk, a nonvolatile memory, and the like. In addition, data 451 such as map data and flight data of the drone 1100 may be stored. Details of the map data and the flight data are similar to those of the first embodiment.

The control unit 460 is a control device that controls the entire control server 3400. The control unit 460 controls other elements included in the control server 3400. The control unit 460 receives a control signal (flight control signal and posture control signal (displacement information)) from the transmission device 1200 and transfers the received control signal to the drone 1100. Furthermore, on the basis of the data 451 such as the map data and the flight data, the control unit 460 may generate a flight plan of the drone 1100 and perform control of the flight based on the flight plan.

As described above, according to the present embodiment, the transmission device 1200 can control the drone 1100 via the control server 3400. Thus, even if the operator is present at a position where the operator cannot visually recognize the drone 1100, the posture or the like of the camera 140 of the drone 1100 can be controlled.

### Fourth Embodiment

A fourth embodiment is a control system using the input terminal 2300 and the transmission device 2200 in the second embodiment instead of the transmission device 1200 in the third embodiment. Note that components similar to those of the first to third embodiments are denoted by the same reference signs, and description thereof will be omitted as appropriate.

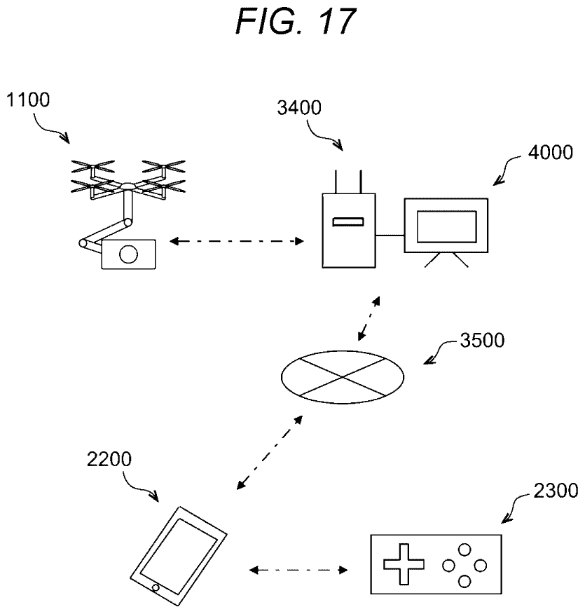

FIG. 17 illustrates a drone control system 4000 according to the embodiment of the present disclosure. The drone control system 4000 includes the drone 1100, the transmission device 2200, the input terminal 2300, the control server 3400, and the network 3500. The transmission device 2200 and the input terminal 2300 are similar to those in the second embodiment. However, the transmission device 2200 communicates with the control server 3400 instead of the drone 1100. Communication between the control server 3400 and the transmission device 2200 is similar to communication between the transmission device 1200 and the control server 3400 in the third embodiment.

As described above, according to the present embodiment, the input terminal 2300 can control the drone 1100 via the transmission device 2200 and the control server 3400. Thus, even if the operator is present at a position where the operator cannot visually recognize the drone 1100, the posture of the camera 140 of the drone 1100 can be easily controlled.

### Fifth Embodiment

A fifth embodiment is a control system that operates a drone including a camera with a zoom mechanism. Components similar to those of the first to fourth embodiments are denoted by the same reference signs, and description thereof will be omitted as appropriate.

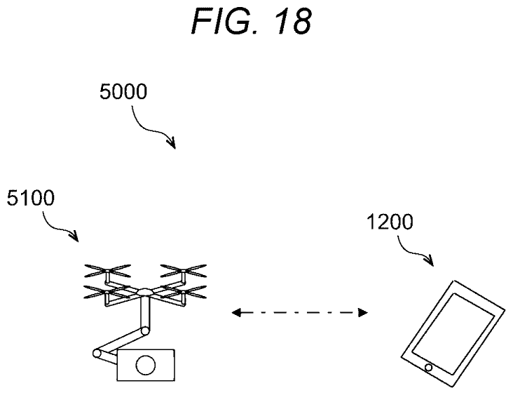

FIG. 18 illustrates a drone control system 5000 according to the embodiment of the present disclosure. The drone control system 5000 includes a drone 5100 and the transmission device 1200. The transmission device 1200 can remotely control the zoom mechanism of the camera mounted on the drone 5100.

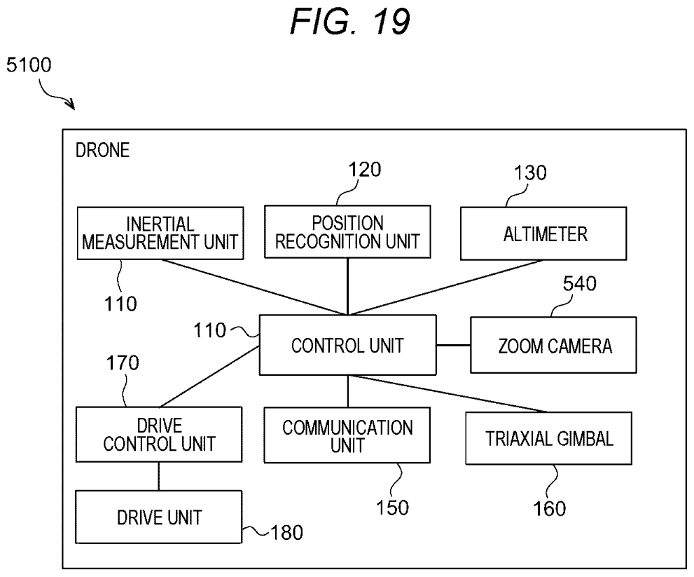

FIG. 19 is a block diagram of the drone 5100. The drone 5100 includes a zoom camera 540 that is a camera including a zoom mechanism. The image can be captured by the zoom camera 540. Other than that, the drone 5100 includes elements similar to those of the drone 1100 of the first embodiment.

The zoom camera 540 is a camera that includes a lens and a zoom mechanism, performs processing of continuously changing a focal length within a certain range, and can control enlargement and reduction of a captured image. Examples of the zoom mechanism include an optical zoom that changes the focal length by moving the position of the lens, and a digital zoom that controls enlargement and reduction of an image by performing software processing on captured image data with the lens itself remaining at the same position.

A block diagram of the transmission device 1200 is FIG. 4, which is the same as that of the first embodiment. A difference from the first embodiment will be mainly described.

In the embodiment of the present disclosure, in a case where the operator presses a finger on the switch button 212 (for example, a button on a touch panel) of the transmission device 1200 to execute/activate the remote control mode, and moves the finger in the upward direction without releasing (keeping the finger in contact), the control unit 260 detects a reduction instruction. The control unit 260 determines a reduction ratio according to the amount of movement of the finger. On the other hand, in a case where the finger is moved downward while being in contact, the control unit 260 detects an enlargement instruction. The control unit 260 determines an enlargement ratio according to the amount of movement of the finger. The control unit 260 generates a zoom control signal (zoom reduction control signal or zoom enlargement control signal) based on the detected reduction instruction or enlargement instruction, and transmits the zoom control signal to the drone 1100.

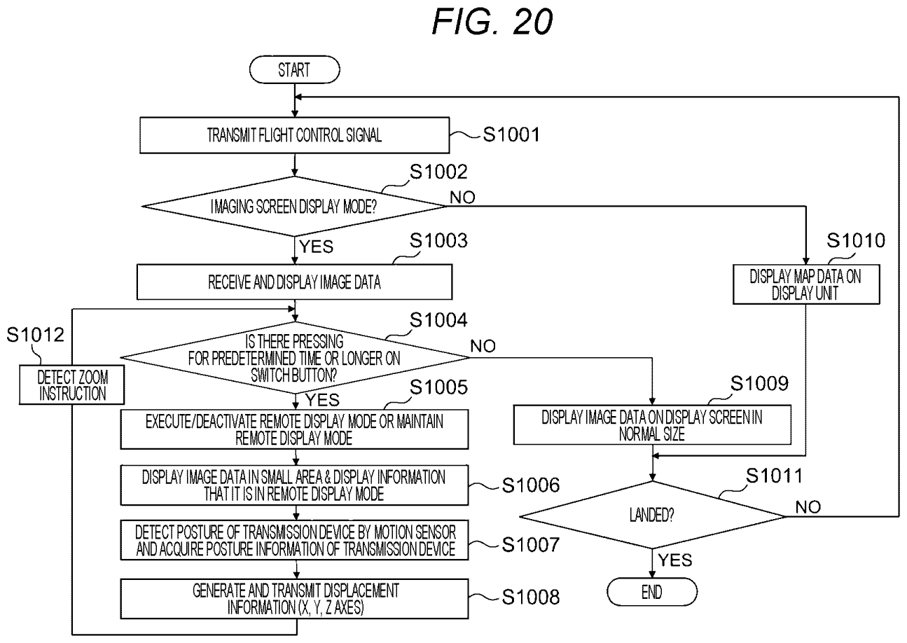

FIG. 20 is a flowchart illustrating an example of processing of the transmission device 1200 in the drone control system 5000. Steps S1001 to S1011 in FIG. 20 are similar to those in the first embodiment, and thus description thereof will be omitted. Step S1012 is added between step S1008 and step S1004. In step S1012, a zooming instruction is detected by the operator.

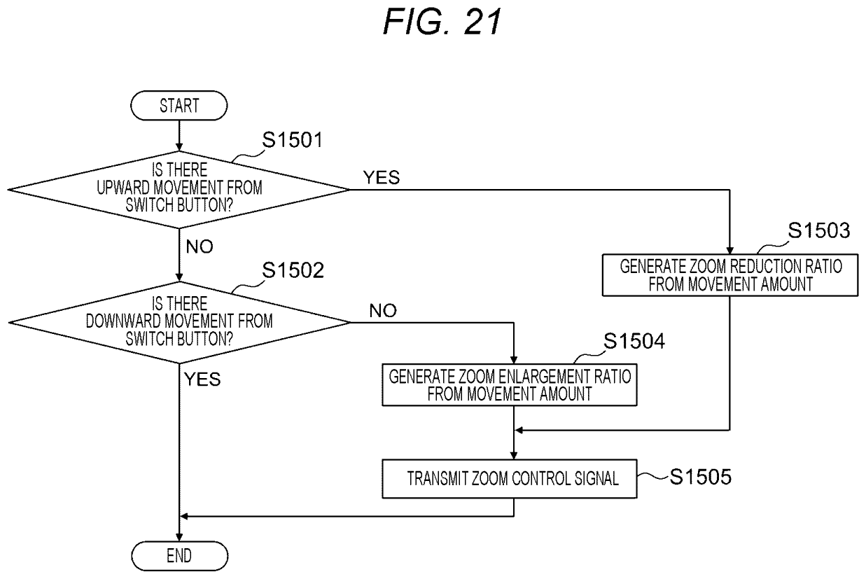

FIG. 21 is a flowchart illustrating an example of the operation of step S1012.

The control unit 260 determines whether the finger pressed on the switch button 212 is moved upward (S1501). In a case where there is the upward movement, the control unit 260 calculates the zoom reduction ratio of the zoom camera 540 from the upward movement amount (S1503). In a case where there is the downward movement, the control unit 260 calculates the zoom enlargement ratio of the zoom camera 540 from the downward movement amount (S1504).

The control unit 260 generates a zoom control signal according to the generated zoom reduction ratio or zoom enlargement ratio, and transmits the zoom control signal to the drone 1100 (S1505). After the transmission of the zoom control signal, the process returns to S1104 in FIG. 20.

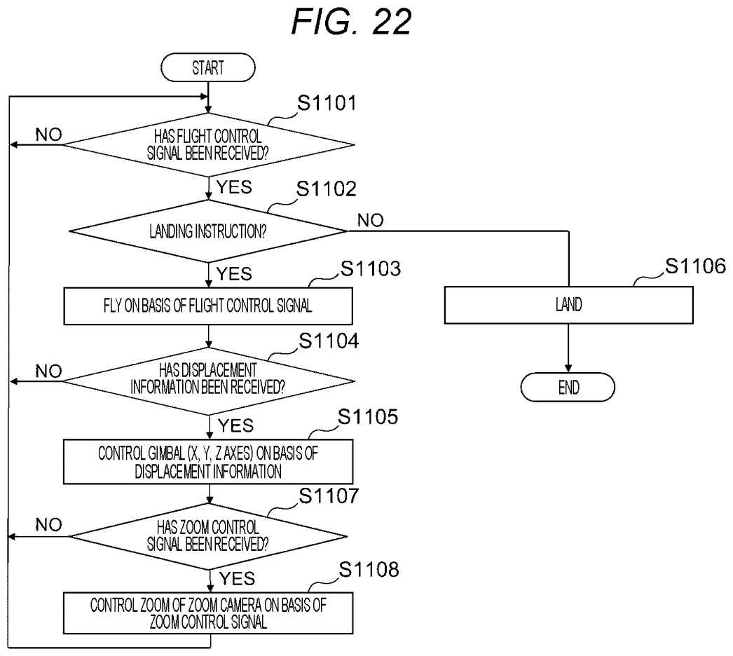

FIG. 22 is a flowchart illustrating an example of processing of the drone 5100. Steps S1101 to S1106 in FIG. 22 are similar to those in the first embodiment, and thus description thereof will be omitted. After step S1105, step S1107 and step S1108 are added.

The control unit 190 determines whether a zoom control signal has been received (S1107). In a case of receiving the zoom control signal, the control unit 190 performs zoom control of the zoom camera 540 on the basis of the zoom control signal (S1108). The zoom camera 540 performs zooming and enlarges or reduces an image on the basis of the control of the control unit 190. The enlarged or reduced image data is transmitted to the transmission device 1200.

As described above, according to the present embodiment, the operator can control the zoom function of the zoom camera 540 by moving the finger upward or downward in the transmission device 1200. That is, it is possible to easily perform an instruction to enlarge or reduce image data captured by the camera 140 of the drone 5100 and display the enlarged or reduced image data on the transmission device 1200 by moving the finger upward or downward.

In the present embodiment, reduction is instructed in a case of moving upward, and enlargement is instructed in a case of moving downward, but this relationship may be reversed. The direction in which the finger is moved may be a horizontal direction instead of the vertical direction, may be an obliquely upper right direction and an obliquely lower left direction, or may be a set of other directions. In addition, instead of moving the finger, reduction or enlargement may be instructed by pinch-out and pinch-in.

### First Modification

In each of the embodiments described above, the drone is provided with the camera whose posture is to be controlled, but the object to be provided with the camera is not limited to the drone. For example, each embodiment is also applicable to a case of controlling the posture of a camera provided for any mobile object such as an AGV, a mobile robot, a train, an automobile, or a submarine. Furthermore, an object to which the camera is provided is not limited to the mobile object. For example, the camera whose posture is to be controlled may be a surveillance camera of a facility such as a house, a building, or a factory.

### Second Modification

In each of the above-described embodiments, in a case where it is detected that the transmission device or the input terminal is no longer held or worn by the operator, the control unit of the transmission device may determine that the operator has instructed the drone to return to a home position (initial position). For example, there is a case where the operator releases the transmission device or the input terminal from the hand and places the transmission device or the input terminal in a place such as a desk. In this case, the control unit of the transmission device may transmit a control signal instructing to return to the home position to the drone or the base station via the communication unit. It is possible to determine that the transmission device or the input terminal is no longer held or worn by the operator, for example, on the basis of a sensing signal of the motion sensor. For example, there is a case where, in a state where the operator's finger is separated from the input unit (for example, the switch button), fluctuation of the sensing signal has disappeared for a certain period of time or more, or has become equal to or less than a threshold. Alternatively, by using a sensing signal of a motion sensor as an input on the basis of a machine-learned learning model, it is also possible to determine whether the transmission device or the input terminal is no longer held or worn by the operator.

Furthermore, the effects of the present disclosure described in the present specification are merely an example, and other effects may be achieved.

Note that the present invention is not limited to the embodiments described above as it is, and can be embodied by modifying the components without departing from the gist thereof in the implementation stage. Furthermore, various inventions can be formed by appropriately combining the plurality of components disclosed in the embodiments described above. For example, some components may be deleted from all the components illustrated in the embodiments. Moreover, the components of different embodiments may be appropriately combined.

Note that the present disclosure can also have the following configurations.

### Item 1

A control method including:
acquiring posture information of an operation device that is able to be held or worn by a user on the basis of a sensing signal of a motion sensor provided in the operation device;
executing/activating a remote control mode for remotely controlling a posture of an imaging device provided in a mobile object on the basis of a first user operation to the operation device;
outputting, to the user, notification information indicating that the remote control mode has been executed/activated; and
controlling the posture of the imaging device on the basis of the posture information during at least a part of a period in which the remote control mode is executed/activated.

### Item 2

The control method according to item 1, further including:
generating a control signal for controlling the posture of the imaging device on the basis of the posture information; and
transmitting the control signal to the mobile object or a base station that relays communication with the mobile object.

### Item 3

The control method according to item 1 or 2, in which
the outputting the notification information to the user includes displaying the notification information on a display screen of the operation device.

### Item 4

The control method according to any one of items 1 to 3, in which
the remote control mode is executed/activated in a case where the first user operation to the operation device continues for a threshold time or longer.

### Item 5

The control method according to item 4, in which
the first user operation on the operation device is to touch or press a button of the operation device.

### Item 6

The control method according to item 3, further including:
receiving image data captured by the imaging device; and
displaying an image on the display screen on the basis of the image data, in which
the outputting the notification information is changing a display area of the image displayed on the display screen.

### Item 7

The control method according to item 6, in which
the display area of the image is changed by changing a part of the image to an image of a predetermined color or an image of a predetermined pattern.

### Item 8

The control method according to item 3, further including:
receiving image data captured by the imaging device; and
displaying an image on the display screen on the basis of the image data, in which
the outputting the notification information includes superimposing text indicating that the remote control mode is executed/activated on the image displayed on the display screen.

### Item 9

The control method according to any one of items 1 to 8, further including:
a first display mode in which an image based on image data captured by the imaging device is displayed on a display screen; and a second display mode in which map data of a peripheral region including a position of the mobile object is displayed on the display screen, in which
the remote control mode is executed/activated only while at least the first display mode is executed.

### Item 10

The control method according to any one of items 1 to 9, further including:
receiving posture information of the imaging device; and
detecting a difference between the posture of the imaging device and a posture of the operation device on the basis of the posture information of the imaging device and the posture information of the operation device, and controlling the posture of the imaging device on the basis of the difference.

### Item 11

The control method according to any one of items 1 to 10, further including:
receiving posture information of the imaging device; and
detecting a difference between the posture of the imaging device and a posture of the operation device on the basis of the posture information of the imaging device and the posture information of the operation device, and executing/activating the remote control mode on the basis of the difference.

### Item 12

The control method according to item 11, in which the remote control mode is executed/activated in a case where the difference becomes equal to or less than a threshold.

### Item 13

The control method according to item 2, in which
the imaging device is provided on the mobile object via a gimbal mechanism, and
the control signal is a signal that controls the gimbal mechanism.

### Item 14

The control method according to item 13, in which
the control signal includes displacement information of the gimbal mechanism.

### Item 15

The control method according to item 5, in which
in a case where the touch or pressing of the button of the operation device is released, the remote control mode is ended.

### Item 16

The control method according to any one of items 1 to 15, further including:
detecting that the operation device is no longer held by the user, and transmitting a control signal instructing the mobile object to return to an initial position to the mobile object or a base station that relays communication with the mobile object.

### Item 17

A control system including:
a mobile object provided with an imaging device; and
an operation device that is able to be held or worn by a user, in which
the operation device includes
a motion sensor that detects a posture of the operation device,
a control unit that executes/activates a remote control mode for remotely operating a posture of the imaging device on the basis of a first user operation to the operation device,
a display unit that outputs notification information indicating that the remote control mode is executed/activated to the user, and
a communication unit that communicates with the mobile object or a base station that relays communication with the mobile object,
the control unit generates a control signal for controlling the posture of the imaging device on the basis of the posture of the operation device detected by the motion sensor during at least a part of a period in which the remote control mode is executed/activated, and
the communication unit transmits the control signal to the mobile object or the base station.

### Item 18

The control system according to item 17, in which
the mobile object includes a control unit that receives the control signal and controls the posture of the imaging device on the basis of the control signal.

### Item 19

The control system according to item 17 or 18, in which
the mobile object includes a gimbal mechanism that supports the imaging device, and
the control unit of the mobile object controls the gimbal mechanism on the basis of the control signal.

### Item 20

A mobile object including:
an imaging device that captures an image of a surrounding environment;
a communication unit that receives a control signal for controlling a posture of the imaging device; and
a control unit that controls the posture of the imaging device on the basis of the control signal, in which
the control signal includes posture information of an operation device that operates the mobile object, and
the communication unit receives the control signal during at least a part of a period in which a remote control mode for remotely operating the imaging device is executed/activated in the operation device.

### REFERENCE SIGNS LIST

1000, 2000, 3000, 4000, 5000 Drone control system
1100, 5100 Drone
1200, 2200 Transmission device
2300 Input terminal
3400 Control server
3500 Network
110 Inertial measurement unit
120 Position recognition unit
130 Altimeter
140 Camera
150 Communication unit
160 Triaxial gimbal
170 Drive unit
180 Drive control unit
190, 260, 360, 460 Control unit
210, 410 Display unit
211 Display screen
2112 Edge image
212 Switch button
220, 320, 420 Communication unit
230, 330, 430 Input unit
240, 340 Motion sensor
250, 350, 450 Storage unit
251, 451 Data
540 Zoom camera

1. A control method comprising:
acquiring posture information of an operation device that is able to be held or worn by a user on a basis of a sensing signal of a motion sensor provided in the operation device;
executing/activating a remote control mode for remotely controlling a posture of an imaging device provided in a mobile object on a basis of a first user operation to the operation device;
outputting, to the user, notification information indicating that the remote control mode has been executed/activated; and
controlling the posture of the imaging device on a basis of the posture information during at least a part of a period in which the remote control mode is executed/activated.

2. The control method according to claim 1, further comprising:
generating a control signal for controlling the posture of the imaging device on a basis of the posture information; and
transmitting the control signal to the mobile object or a base station that relays communication with the mobile object.

3. The control method according to claim 1, wherein
the outputting the notification information to the user includes displaying the notification information on a display screen of the operation device.

4. The control method according to claim 1, wherein
the remote control mode is executed/activated in a case where the first user operation to the operation device continues for a threshold time or longer.

5. The control method according to claim 4, wherein
the first user operation on the operation device is to touch or press a button of the operation device.

6. The control method according to claim 3, further comprising:
receiving image data captured by the imaging device; and
displaying an image on the display screen on a basis of the image data, wherein
the outputting the notification information is changing a display area of the image displayed on the display screen.

7. The control method according to claim 6, wherein
the display area of the image is changed by changing a part of the image to an image of a predetermined color or an image of a predetermined pattern.

8. The control method according to claim 3, further comprising:
receiving image data captured by the imaging device; and
displaying an image on the display screen on a basis of the image data, wherein
the outputting the notification information includes superimposing text indicating that the remote control mode is executed/activated on the image displayed on the display screen.

9. The control method according to claim 1, further comprising:
a first display mode in which an image based on image data captured by the imaging device is displayed on a display screen; and
a second display mode in which map data of a peripheral region including a position of the mobile object is displayed on the display screen, wherein
the remote control mode is executed/activated only while at least the first display mode is executed.

10. The control method according to claim 1, further comprising:
receiving posture information of the imaging device; and
detecting a difference between the posture of the imaging device and a posture of the operation device on a basis of the posture information of the imaging device and the posture information of the operation device, and controlling the posture of the imaging device on a basis of the difference.

11. The control method according to claim 1, further comprising:
receiving posture information of the imaging device; and
detecting a difference between the posture of the imaging device and a posture of the operation device on a basis of the posture information of the imaging device and the posture information of the operation device, and executing/activating the remote control mode on a basis of the difference.

12. The control method according to claim 11, wherein the remote control mode is executed/activated in a case where the difference becomes equal to or less than a threshold.

13. The control method according to claim 2, wherein
the imaging device is provided on the mobile object via a gimbal mechanism, and
the control signal is a signal that controls the gimbal mechanism.

14. The control method according to claim 13, wherein
the control signal includes displacement information of the gimbal mechanism.

15. The control method according to claim 5, wherein
in a case where the touch or pressing of the button of the operation device is released, the remote control mode is ended.

16. The control method according to claim 1, further comprising:
detecting that the operation device is no longer held by the user, and transmitting a control signal instructing the mobile object to return to an initial position to the mobile object or a base station that relays communication with the mobile object.

17. A control system comprising:
a mobile object provided with an imaging device; and
an operation device that is able to be held or worn by a user, wherein
the operation device includes
a motion sensor that detects a posture of the operation device,
a control unit that executes/activates a remote control mode for remotely operating a posture of the imaging device on a basis of a first user operation to the operation device,
a display unit that outputs notification information indicating that the remote control mode is executed/activated to the user, and
a communication unit that communicates with the mobile object or a base station that relays communication with the mobile object,
the control unit generates a control signal for controlling the posture of the imaging device on a basis of the posture of the operation device detected by the motion sensor during at least a part of a period in which the remote control mode is executed/activated, and
the communication unit transmits the control signal to the mobile object or the base station.

18. The control system according to claim 17, wherein
the mobile object includes a control unit that receives the control signal and controls the posture of the imaging device on a basis of the control signal.

19. The control system according to claim 17, wherein
the mobile object includes a gimbal mechanism that supports the imaging device, and
the control unit of the mobile object controls the gimbal mechanism on a basis of the control signal.

20. A mobile object comprising:
an imaging device that captures an image of a surrounding environment;
a communication unit that receives a control signal for controlling a posture of the imaging device; and
a control unit that controls the posture of the imaging device on a basis of the control signal, wherein the control signal includes posture information of an operation device that operates the mobile object, and
the communication unit receives the control signal during at least a part of a period in which a remote control mode for remotely operating the imaging device is executed/activated in the operation device.
